(19) United States
(12) Patent Application Publication
(10) Pub. No.: US 2008/0298724 A1
(43) Pub. Date: Dec. 4, 2008

(54) AIR PACKING BAG FOR TIGHTLY HOLDING ARTICLE AND MANUFACTURE THEREOF

(75) Inventors: Chieh-Hua Liao, Sindian City (TW); Yaw-Shin Liao, Sindian City (TW); Yao-Chuan Liao, Sindian City (TW)

Correspondence Address: APEX JURIS, PLLC, 12360 LAKE CITY WAY NORTHEAST, SUITE 410, SEATTLE, WA, 98125, US

(73) Assignee: Chieh-Hua Liao, Sindian City (TW)

(21) Appl. No.: 11/969,452

(22) Filed: Jan. 4, 2008

(30) Foreign Application Priority Data
Jun. 4, 2007 (TW) 096119934

(51) Int. Cl. B65D 30/00; B32B 38/18; B65D 33/00; B65B 31/00; B65B 63/00; B65B 51/10

(52) U.S. Cl. 383/3; 156/227; 383/94; 53/403; 53/435; 53/477

(57) ABSTRACT

According to an air packing bag for tightly holding an article and manufacture thereof of the present invention, a first outer film and a second outer film are staked together, in which the first outer film comprises a first side, a second side and a foldable side. The foldable side is positioned between the first side and the second side and an accepting space is formed on the first outer film after the first outer film is folded up along the foldable side. Next, the first film is pierced through to form at least one air inlet thereon, a periphery of the air inlet is hot-sealed, the second outer film is folded up and stacked on an outer side of the first outer film, the first outer film and the second outer film are adhered to each other to form a hot sealing side on a folded side thereof, and the first outer film is adhered to the second outer film by means of hot sealing to form a first air chamber between the first side and the hot sealing side as well as a second air chamber between the second side and the hot sealing side.

### CROSS-REFERENCES TO RELATED APPLICATIONS

This non-provisional application claims priority under 35 U.S.C. §119(a) on Patent Application No(s). 096119934 filed in Taiwan, R.O.C. on Apr. 6, 2007, the entire contents of which are hereby incorporated by reference.

### FIELD OF INVENTION

The present invention relates to an air packing bag and a manufacture thereof, and more particularly to an air packing bag for tightly holding an article and manufacture thereof.

### BACKGROUND

Generally, an article is directly placed into a paper box while being packed. However, the paper box can only be used for packing the article and has no cushioning protection function to cause the article to be damaged easily owing to shake while being transported such that cushioning material is usually placed in the paper box during the packing to elevate the cushioning protection function of the paper box. A general used way is to fill foam between the article and the paper box thereby using the softness of the foam to provide the cushioning protection for the article. However, the price of foam is so high as to cause the packing cost to be increased and thus, it is of no economic interest. Besides, foam is not easy to be processed such that it is harmful to the environment protection. Moreover, although the foam can be tightly attached onto a surface of the article, the collision prevention effect is not good such that the article is still often subjected to collision to cause damage.

Another common cushioning material is Styrofoam. An article is first wrapped by means of Styrofoam, and then placed in a paper box so as to prevent the article from being collided during the transportation. Although Styrofoam can prevent the article from being damaged due to shake, the volume of Styrofoam fluffily occupies a great deal of space and not easy to be decomposed by microorganism as well as will release poison gas to endanger human bodies during an incineration process to cause a serious environmental pollution; Styrofoam is not an ideal cushioning material in nowadays of environmental consciousness upsurge. Moreover, Styrofoam with a fixed size cannot be used for packing all different dimensions and sizes of articles; a different dimension of Styrofoam must be only used for a specific article; this not only is resources wasting but also increases the article packing cost.

For solving the problems mentioned above, an air packing bag made by hot-sealing two sheets of thin plastic film is generated thereby providing a cushioning protection use to an article while being shaken. Although the air packing bag can provide a better cushioning protection, the article is easy to pierce the air packing bag through due to the shake in the air packing bag if the article is provided with sharp angles or hardware joint corners. If a small breach appears on the air packing bag, air in the air packing bag will then be leaked out to cause the air packing bag to loose the cushioning protection effect and further to increase the article packing cost. For solving this problem, the thin plastic film of the air packing bag may be thickened or strengthened so as to avoid being pierced through by the article as far as possible. But, it is impossible to strengthen or thicken only one single face of the air packing bag in a continuous mass production, all faces of the air packing bag must be strengthened or thickened; it leads to a high production cost to loose the market competitiveness.

### SUMMARY

For providing an article with a good cushioning protecting, preventing the article from being damaged or scratched owing to collision during the transportation, solving the problem that an air packing bay is easy to be pierced through by the article and further decreasing the production cost of a cushioning material, the present invention is proposed.

Seeing this, the present invention proposes an air packing bag for tightly holding an article; it comprises a first outer film comprising a first side, a second side and a foldable side positioned between the first and the second side, an accepting space formed on the first outer film after the first film is folded up along the foldable side and used for depositing an article, a second outer film positioned outside the first outer film after being folded up, two inner films with a heat resistant material spread between them positioned between the first outer film and the second outer film, a hot sealing side positioned on one folded side of the first outer film and the second outer film and formed by adhering the first outer film to the second outer film by means of hot sealing, at least one first chamber positioned between the first side and the hot sealing side and provided with a storable air space formed by adhering the first outer film to the second outer film by means of hot sealing, at least one second air chamber positioned between the second side and the hot sealing side and provided with an air storable space formed by adhering the first outer film to the second outer film by means of hot sealing, at least one air inlet positioned on the first outer film and used for communicating the first air chamber with the second air chamber and at least one air entrance formed by adhering the two inner films by means of hot sealing to allow air to enter the first chamber and the second air chamber via the air entrance to cause the first chamber and the second air chamber to be filled with air to expanded.

The present invention also proposes a manufacturing method for an air packing bag for tightly holding an article; it comprises the following steps: providing a first outer film and a second outer film in which the first outer film comprises a first side, a second side and a foldable side positioned between the first side and the second side, providing two inner films positioned between the first outer film and the second outer film in which a heat resistant material is spread between the two inner films, folding up the first outer film along the foldable side to form an accepting space on the first outer film to be used for depositing an article, piercing through the first outer film to form at least one air inlet, hot-sealing a periphery of each air inlet, folding up the second outer film and staking the folded-up second outer film on an outer side of the folded-up first outer film, hot-sealing the first outer film and the second outer film to form a hot sealing side on a folded side of the first outer film and the second outer film and hot-sealing the first outer film and the second outer film to form at least one first air chamber between the first side and the hot sealing side and at least one second air chamber between the second side and the hot sealing side.

According to the present invention, an article is accepted in the accepting space. When the first air chamber and the second air chamber are filled with air and expanded, the first air chambers and the second air chambers can then be used to hold the article tightly to enable the article to be fixed in the accepting space and not to be shaken with the air packing bag thereby not only enforcing the cushioning protection to the article but also solving the problem that a conventional air packing bag is pierced through easily by an article.

### BRIEF DESCRIPTION OF THE DRAWINGS

The present invention can be more fully understood by reference to the following description and accompanying drawings, in which:

FIG. 1 is a schematic view, showing an air packing bag of a first preferred embodiment according to the present invention before hot sealing is processed in which a first outer film is not folded;

FIG. 2 is a schematic view, showing an air packing bag of the first preferred embodiment according to the present invention before hot sealing is processed in which the first outer film is folded up;

FIG. 3A is a cross sectional view, showing the air packing bag of the first preferred embodiment according to the present invention after air is filled;

FIG. 3B is a partly enlarged schematic view of FIG. 3B;

FIG. 4 is a cross sectional view, showing that an article is placed in the air packing bag after air is filled according to the first embodiment of the present invention;

FIG. 5 is a perspective view, showing that the article is placed in the air packing bag after air is filled according to the first embodiment of the present invention;

FIG. 6A is a cross sectional view, showing an air packing bag after air is filled according to a third preferred embodiment of the present invention;

FIG. 6B is a partly enlarged schematic view of FIG. 6A;

FIG. 7 is a plane view, showing an air packing bag before air is filled according to a third preferred embodiment of the present invention;

FIG. 8 is a cross sectional view, showing that an article is placed in an air packing bag after air is filled according to a fourth preferred embodiment of the present invention;

FIG. 9 is a plane view, showing an air packing bag before air is filled according to a fifth preferred embodiment of the present invention; and

FIG. 10 is a cross sectional view, showing that an article is placed in the air packing bag after air is filled according to the fifth embodiment of the present invention.

### DETAILED DESCRIPTION

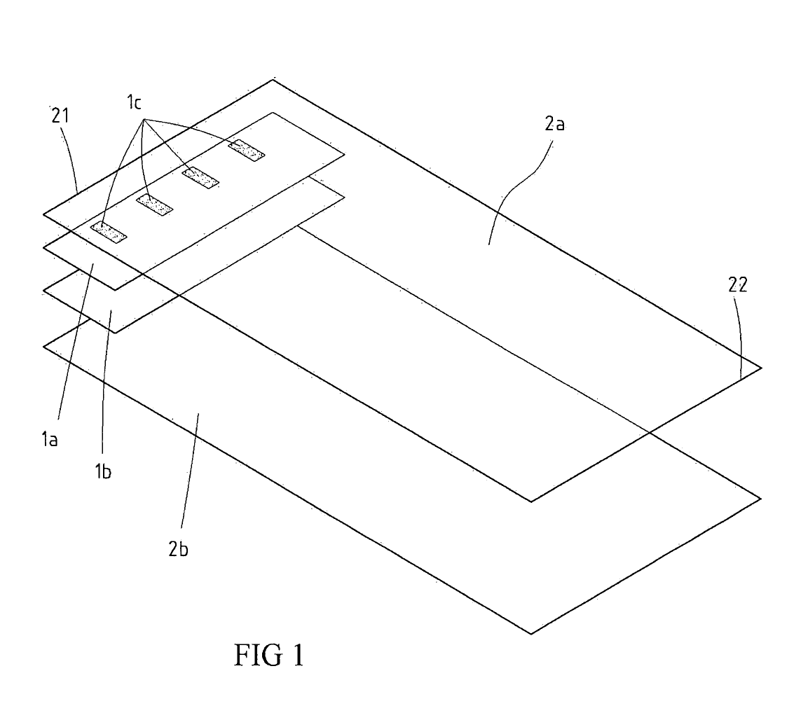

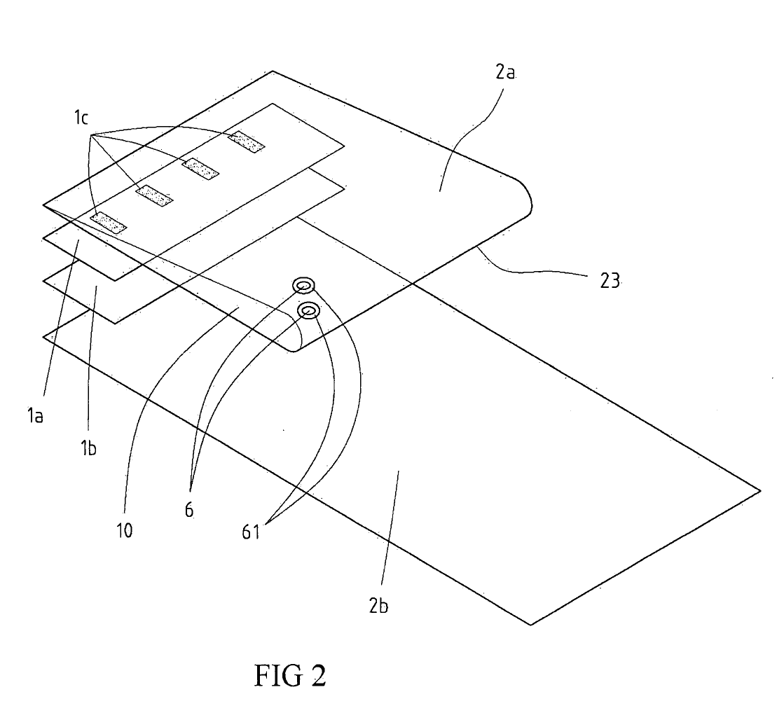

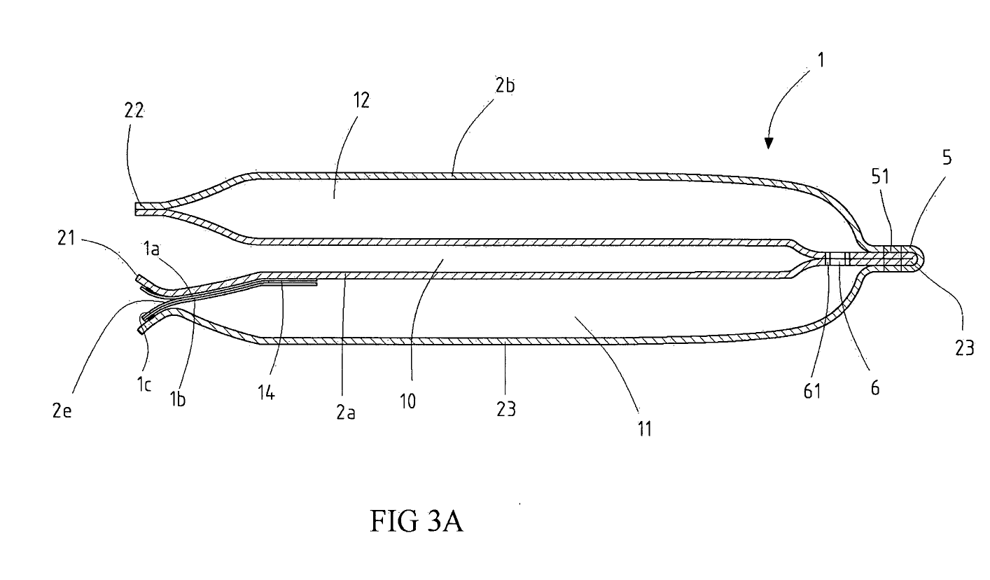

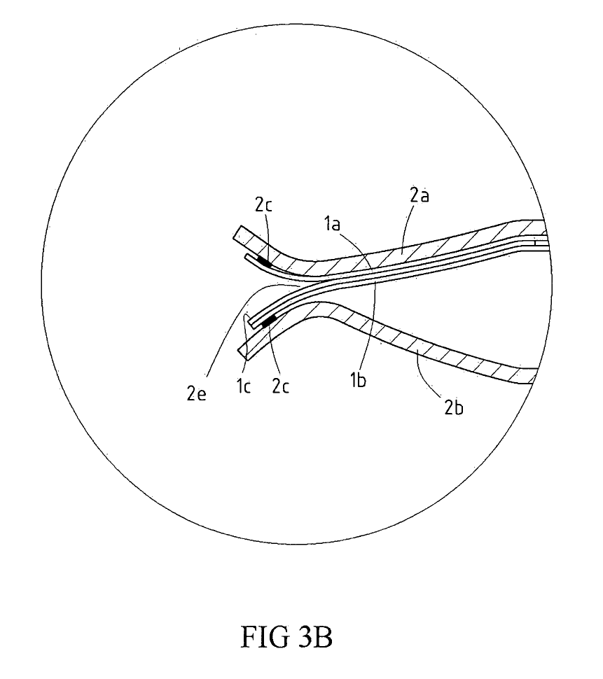

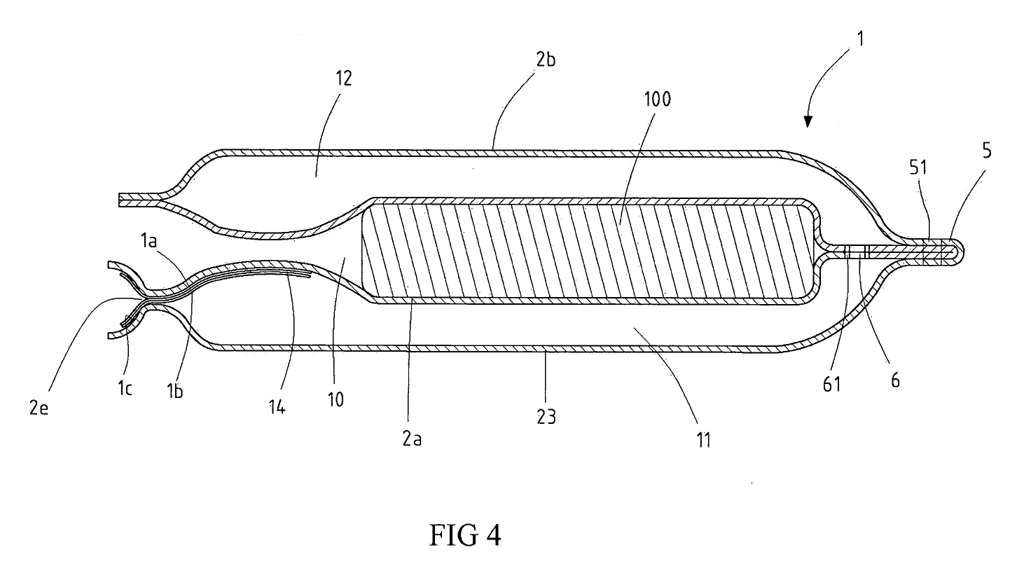

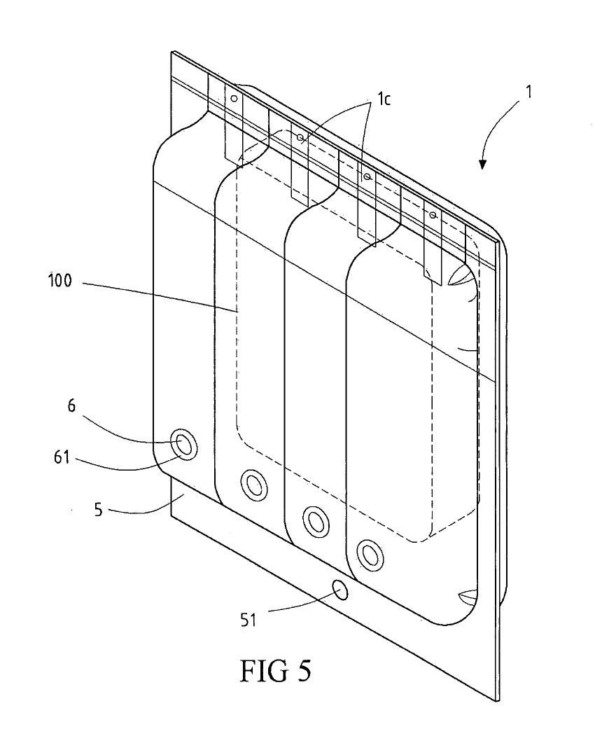

Please refer to FIGS. 1 to 5. FIG. 1 is a schematic view, showing an air packing bag of a first preferred embodiment according to the present invention before hot sealing is processed in which a first outer film is not folded. FIG. 2 is a schematic view, showing an air packing bag of the first preferred embodiment according to the present invention before hot sealing is processed in which the first outer film is folded up. FIG. 3A is a cross sectional view, showing the air packing bag of the first preferred embodiment according to the present invention after air is filled. FIG. 3B is a partly enlarged schematic view of FIG. 3B. FIG. 4 is a cross sectional view, showing that an article is placed in the air packing bag after air is filled according to the first embodiment of the present invention. FIG. 5 is a perspective view, showing that the article is placed in the air packing bag after air is filled according to the first embodiment of the present invention.

An air packing bag for tightly holding an article comprises a first outer film 2a, a second outer film 2b, a hot sealing side 5, a first air chamber 11, a second air chamber 12 and air inlet 6.

The first outer film 2a comprises a first side 21, a second side 22 and a foldable side 23, in which the foldable side 23 is positioned between the first 21 and the second side 22. An accepting space 10 is formed between upper and lower pars of the folded first outer film 2a after the first outer film 2a is folded up along the foldable side 23 and used for depositing an article 100.

The second outer film 2b is stacked on the first outer film 2a in the same direction after being folded up to cause both the first outer film 2a and the second outer film 2b to face the same direction after being folded up, and the second outer film 2b is positioned outside the first outer film 2a.

The hot sealing side 5 is positioned on one folded side of the first outer film 2a and the second outer film 2b and formed by adhering the first outer film 2a to the second outer film 2b by means of hot sealing.

The structure disclosed by the present invention further comprises suspension hole 51, positioned on the hot sealing side 5 and used for allowing the air packing bag 1 to be hung on a hook so as to be convenient for a user to display or store the air packing bag 1 and the article 100.

At least one first air chamber 11 is positioned between the first side 21 and the hot sealing side 5, and is an air storable space formed by adhering the first outer film 2a to the second outer film 2b by means of hot sealing, in which hot sealing may be a hot mold pressing.

At least one second air chamber 11 is positioned between the second side 21 and the hot sealing side 5, and is an air storable space formed by adhering the first outer film 2a to the second outer film 2b by means of hot sealing.

At least one air inlet is positioned on the first outer film 2a and used for communicating the first air chamber 11 with the second air chamber 12, in which the air inlet 6 is formed by piercing through the first outer film 2a after being folded up, and a periphery 61 of the air inlet 6 is then hot-sealed to cause the accepting space 10 not to be communicated with the first air chamber 11 and the second air chamber 12.

According to the structure disclosed by the present invention, the air packing bag 1 further comprises two sheets of inner film 1a and 1b positioned between the first outer film 2a and the second outer film 2b. Furthermore, hot sealing points 2c are generated so as to adhere the first outer film 2a to the inner film 1a and the second outer film 2b to the inner film 1b. Besides, the two sheets of inner film 1a and 1b are not adhered to each other even by means of hot sealing to form at least one air entrance 2a after a heat resistant material 1c is spread between the two sheets of inner film 1a and 1b; the air entrance 2e is used for allowing the first air chamber 11 and the second air chamber 12 to communicate with each other to enable air to flow in the first air chamber 11 and the second air chamber 12 via the air entrance 2e to cause them to be filled with air and expanded.

When a user places the article 100 into the accepting space 10 to pull the first outer film 2a and the second outer film 2b apart outward and in the meantime, the two sheets of inner film 1a and 1b are driven to hold open outward through the hot sealing points 2c so as to open the air entrance 2e to enable air to enter the first air chamber 11 via the air entrance 2e, in which one part of air flows into the second air chamber 12 via the air inlet 6 so as to cause the first air chamber 11 and the second air chamber 12 to be filled with air and expanded. After the first air chamber 11 and the second air chamber 12 are filled with air and expanded, internal air pressure in the first air chamber 11 compress the two sheets of inner film 1a and 1b to attach onto the first outer film 2a or the second outer film 2b (depending on difference of a structure thereof, the two inner films 1a and 1b may also not be side-attached on the first outer film 2a or the second outer film 2b but hung in the air in the first air chamber) to cover the air entrance 2e and shield the first air chamber 11 to allow the air in the first air chamber 11 and the second air chamber 12 not to be leaked out to attained to the airtight effect.

After the first air chamber 11 and the second air chamber 12 are filled with air and expanded, the article 100 can then be constricted through the first air chamber 11 and the second air chamber 12 to enable the article 100 to be fixed in the accepting space 10 and not to be shaken with the air packing bag 1 so that the cushioning protection of the article 100 can be enforced. Besides, if the article 10 has a sharp angle or a hardware joint corner, the air packing bag 1 can also avoid being pierced through by the sharp angle or the hardware joint corner by preventing the article 100 from be shaken.

Furthermore, the first air chamber 11 and the second air chamber 12 may also first be filled with air. The article is not placed in the accepting space until the air filling and the expansion of the first air chamber 11 and the second air chamber 12 are completed

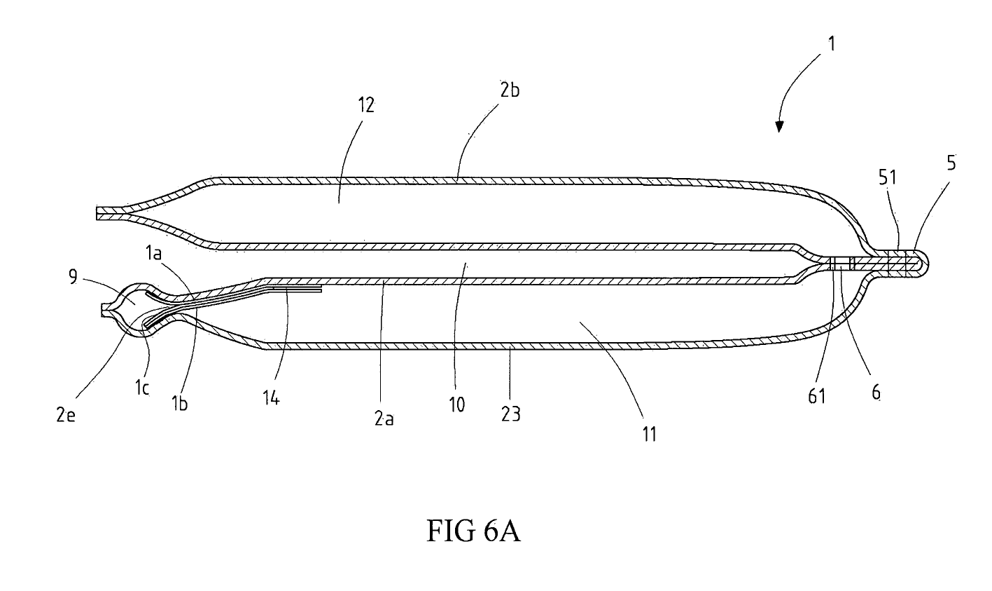

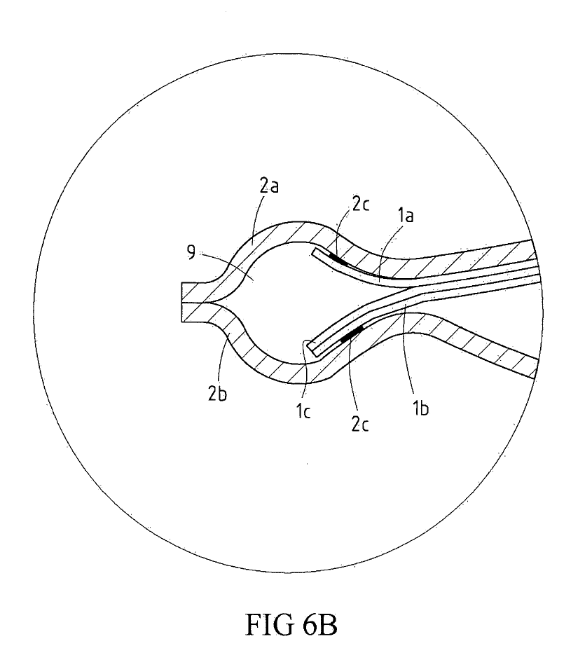

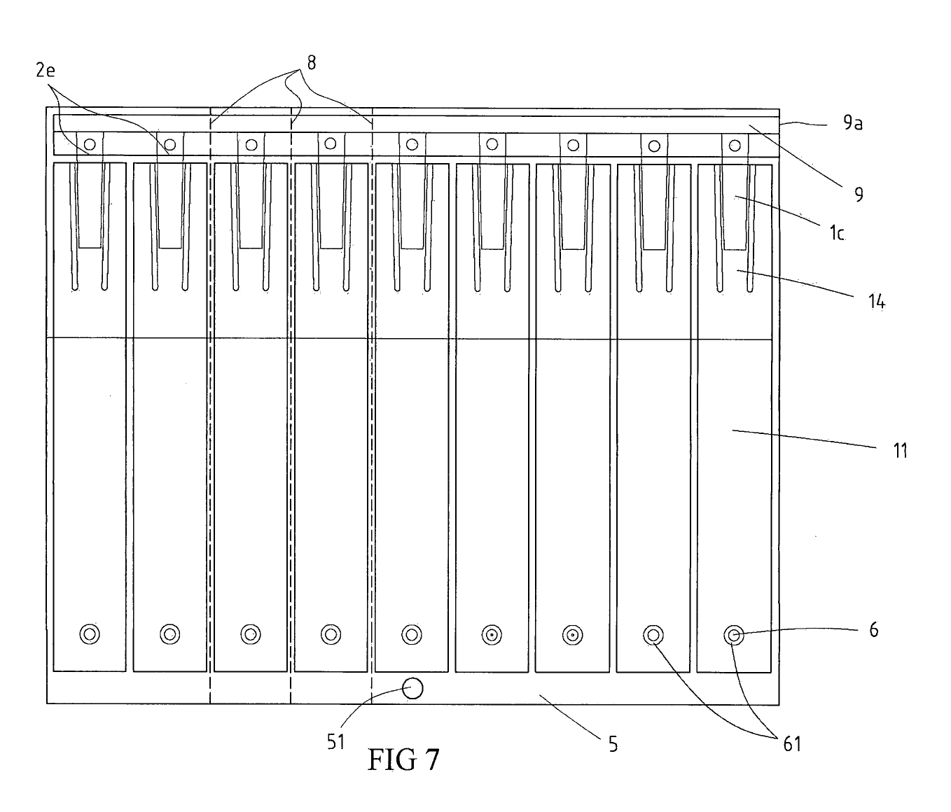

Please refer to FIGS. 6A, 6B and 7. FIG. 6A is a cross sectional view, showing an air packing bag after air is filled according to a third preferred embodiment of the present invention. FIG. 6B is a partly enlarged schematic view of FIG. 6A. FIG. 7 is a plane view, showing an air packing bag before air is filled according to a third preferred embodiment according to the present invention.

The air packing bag further comprises an air filling passageway 9 positioned at one side of the first air chambers 11 to allow the air chambers to be disposed side by side at one side of the air filling passageway 9, in which the air filling passageway 9 is an air passable space formed by adhering the first outer film 2a to the second outer film 2b by means of hot sealing and an air filling entrance 9a is formed on one end of the air filling passageway 9. Besides, each air entrance 2e is connected to an air passageway 14, in which the air passageway 14 is formed between the two inner films 1a and 1b by adhering the two sheets of film 1a and 1b to each other by means of hot sealing after a heat resistant material 1c is spread between the two sheets of inner film 1a and 1b.

After air entering the air filling entrance 9a expands the air filling passageway, it pulls the first outer film 2a and the second outer film 2b apart outward to open each air entrance 2e to allow the air in the air filling passageway 9 to be filled in the plurality of first air chambers 11 via each air entrance 2e and each air passageway 14. A part of the air flows into the second air chamber 12 via air inlet 6 to cause the first air chamber 11 and the second air chamber 12 to be filled with air and expanded thereby being capable of processing air filling to the plurality of first air chambers 11 and second air chambers 12 simultaneously to reduce the air filling time effectively and elevate the air filling efficiency substantially.

After the first air chamber 11 and the second air chamber 12 are filled with air and expanded, internal air pressure in the first air chamber 11 compresses the two sheets of inner film 1a and 1b to attach onto the first outer film 2a or the second outer film 2b (depending on difference of a structure thereof, the two inner films 1a and 1b may also not be side-attached on the first outer film 2a or the second outer film 2b but hung in the air in the first air chamber) to cover the air passageway 14 and shield the first air chamber 11 to allow the air in the first air chamber 11 and the second air chamber 12 not to be leaked out to attained to the airtight effect.

Furthermore, a cutting line may respectively be disposed between each two adjacent first air chambers 11 and between each two adjacent second air chambers 12 thereby allowing a user to process cutting along the cutting lines to enable each set of first air chamber 11 and second air chamber 12 can be used independently.

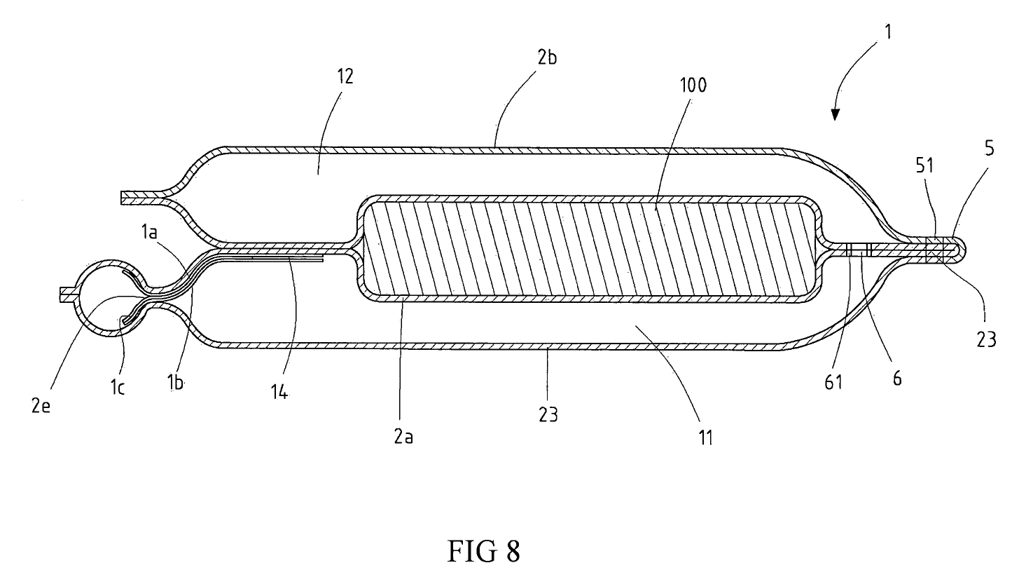

Please refer to FIG. 8. FIG. 8 is a cross sectional view, showing that an article is placed in an air packing bag after air is filled according to a fourth preferred embodiment of the present invention.

After a user places the article 100 in the accepting space 10, the first air chamber 11 and the second air chamber 12 then tightly hold the article 100 after being filled with air and air in the accepting space 10 is further evacuated to enforce the effect that the first air chamber 11 and the second air chamber 12 tightly hold the article 100 to enable the article to be fixed in the accepting space 10 and not to be shaken with the air packing bag 1. After the air evacuation is completed, the two parts of the first outer film 2a are adhered together by means of hot sealing to shield the accepting space 10 to allow the article 100 not to escape from the accepting space 10.

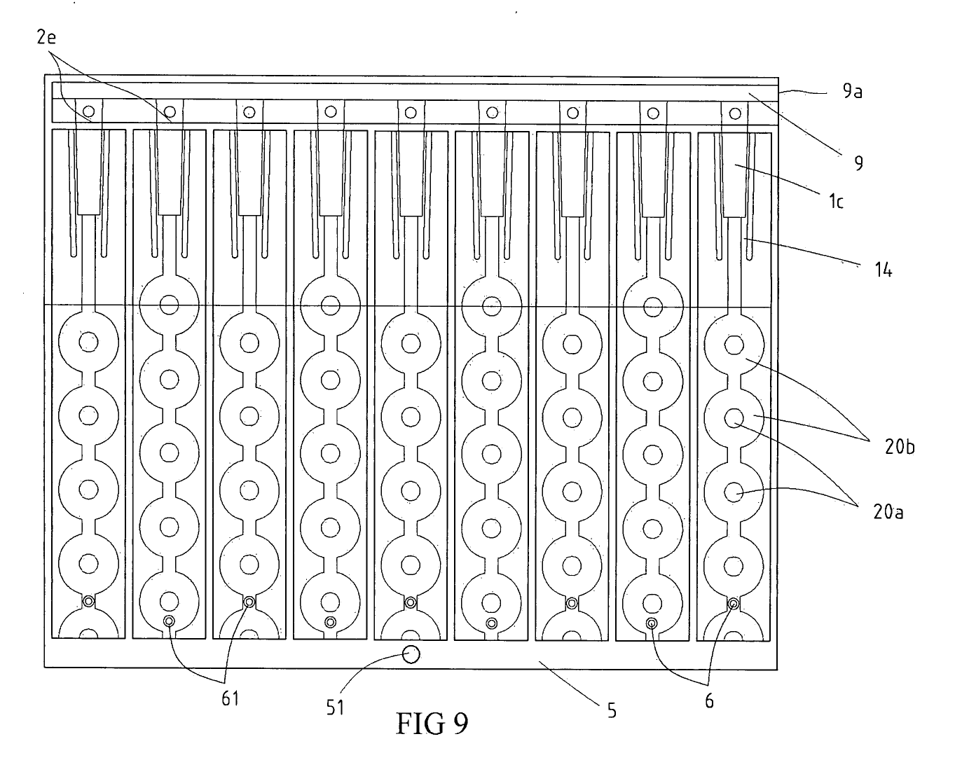

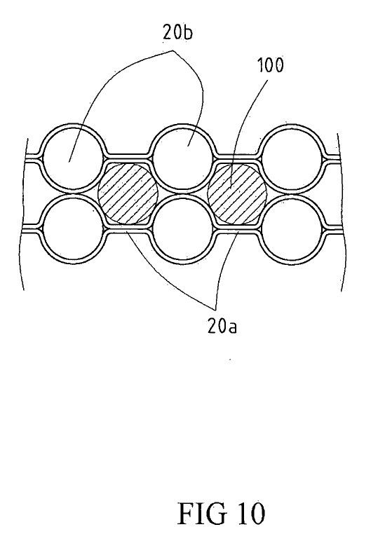

Please refer to FIGS. 9 and 10. FIG. 9 is a plane view, showing an air packing bag before air is filled according to a fifth preferred embodiment of the present invention. FIG. 10 is a cross sectional view, showing that an article is placed in the air packing bag after air is filled according to the fifth embodiment of the present invention.

The air packing bag further comprises at least one hot pressing node 20a and at least one circular loop portion 20b, in which the hot pressing nodes 20a are formed by adhering the first outer film 2a to the second outer film 2b by means of hot sealing and each circular loop portion 20b surrounds each hot pressing node 20a. When the first air chamber 11 and the second air chamber 12 are filled with air and expanded, the article 100 is let in the hot pressing nodes 20a and the wrapped by the circular loops portions 20b; this not only prevents the article 100 from being shaken with the air packing bag 1 but also enforces the cushioning protection to the article 100.

A manufacturing method for an air packing bag for tightly holding an article comprises the following steps:

Step 1: providing a first outer film 2a and a second outer film 2b, in which the first outer film 2a comprises a first side 21, a second side 22 and a foldable side 23, and the foldable side 23 is positioned between the first side 21 and the second side 22.

The method disclosed by the present invention further comprises providing two sheets of inner film 1a and 1b positioned between the first outer film 2a and the second outer film 2b and generating hot sealing points 2c by means of hot sealing thereby adhering the first outer film 2a to the inner film and the second outer film 2b to the inner film 1b. after a heat resistant material 1c is spread between the two inner films 1a and 1b, at least one air entrance 2e used for allowing the first air chamber 11 to communicate with the outside to enable air enter the first air chamber 11 and the second air chamber 12 to cause them to be filled with air and expanded via the air entrance 2e is formed between the two inner films 1a and 1b by not adhering the two inner film 1a and 1b to each other even by means of hot sealing. Besides, each air entrance 2e is connected to an air passageway 14, in which the air passageway 14 is formed between the two sheets of inner film 1a and 1b by adhering the two sheets of inner film 1a and 1b to each other by means of hot sealing after a heat resistant material is spread between the two sheets of inner film 1a and 1b.

Step 2: folding the first outer film 2a along the foldable side 23 to form an accepting space 10 between upper and lower parts of the folded first outer film 2a to used for depositing the article 100.

After the first outer film 2a is folded up along the foldable side 23, the second side 22 may be allowed to position above the first side 21 or the first side 21 may be allowed to position above the second side 22.

Step 3: piercing through the first outer film 2a to form at least one air inlet 6.

Here, the first outer film 2a and the second outer film 2b are first separated from each other by a spacer so as to allow the first outer film 2a to be pierced through without influencing the second outer film 2b to form vertically corresponding air inlets 6 on the folded first outer film 2a.

Step 4: hot-sealing a periphery 61 of the air inlet 6.

Step 5: folding up the second outer film 2b and stacking it on an outer side of the first outer film 2a.

The second outer film 2b is stacked on the first outer film 2a in the same direction to cause both the first outer film 2a and the second outer film 2b to face in the same direction after being folded up, and the second outer film 2b is positioned on the outer side of the first outer film 2a.

Adhering the first outer film 2a to the second outer film 2b by means of hot sealing to form a hot sealing side 5 on a folded side of the first outer film 2a and the second outer film 2b.

Besides, a suspension hole 51 may also be disposed on the hot sealing side 5 to allow the air packing bag 1 to be hung on a hook so as to be convenient for displaying or storing the air packing bag 1 and the article 100.

Step 7: adhering the first outer film 2a to the second outer film 2b by means of hot sealing to form at least one first air chamber 11 between the first outer film 2a and the hot sealing side 5 and at least one second air chamber 12 between the second side 22 and the hot sealing side 5.

Here, the first air chamber is communicated with the second air chamber 12 through the air inlet 6 and the accepting space is not communicated with the first air chamber 11 and the second air chamber 12.

Furthermore, an air filling passageway 9 is formed by adhering the first outer film 2a to the second outer film 2b by means of hot sealing, and an air filling entrance 9a is formed on one end of the air filling passageway 9, and the air filling passageway 9 is positioned at one side of the first air chambers 11 to allow the first air chamber 1 to be disposed side by side at one side of the air filling passageway 9.

After air entering the air filling entrance 9a expands the air filling passageway, it pulls the first outer film 2a and the second outer film 2b apart outward to open each air entrance 2e to allow the air in the air filling passageway 9 to be filled in the plurality of first air chambers 11 via each air entrance 2e and each air passageway 14. A part of the air flows into the second air chamber 12 via air inlet 6 to cause the first air chamber 11 and the second air chamber 12 to be filled with air and expanded.

Besides, a cutting line may respectively be disposed between each two adjacent first air chambers 11 and between each two adjacent second air chambers 12 thereby allowing a user to process cutting along the cutting lines to enable each set of first air chamber 11 and second air chamber 12 to be used independently.

Besides, the method further comprises placing the article 100 in the accepting space 100 and evacuating air in the accepting space to allow the first air chambers 11 and the second air chambers 12 to tightly hold the article to cause the article 100 to be fixed in the accepting space 10 and not to be shaken with the air packing bag 1. After the air evacuation is completed, the upper and the lower parts of the folded first outer film 2a are adhered to each other by means of hot sealing to enable the article 100 not to escape from the accepting space 10.

In the present invention, not only the first air chambers 11 and the second air chambers 12 may first be filled with air, the article 100 is not placed in the accepting space 10 until the air filling and the expansion of the first air chambers 11 and the second air chambers 12 are completed, but also the article 100 may be placed in the accepting space 10 first and the first air chambers 11 and the second air chambers are then filled with air.

The method disclosed by the present invention may further comprise adhering the first outer 2a to the second outer film 2b by means of hot sealing to form hot pressing nodes 20a and a circular loop portion 20b is formed around each hot pressing node 20a; each circular loop portion 20b surrounds each hot pressing node 20a. When the first air chambers 11 and the second air chambers 12 are filled with air and expanded, the article is let in the hot pressing nodes 20a and wrapped by the circular loop portions 20b.

The plurality of first air chambers 11 and second air chambers 12 are filled with air simultaneously by means of a continuous air filling air valve structure according to the present invention, and the article 100 is allowed to be fixed in the accepting space 10 and not to be shaken with the air packing bag 1; this not only enforces the cushioning protection to the article 100 but also prevents the air packing bag 1 from being pierced through due to the shake of the article 100. Besides, that the first outer film 2a and the second outer film 2b need not be enforced or thickened extraordinarily can decrease the production cost of the air packing bag 1 substantially even more.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An air packing bag for tightly holding an article, comprising:
a first outer film, comprising a first side, a second side and a foldable side, said foldable side being positioned between the first side and the second side;
an accepting space, formed between upper and lower parts of the folded first outer film after the first outer film is folded up along the foldable side and used for depositing an article;
a second outer film, folded up and staked on an outer side of the first outer film;
two inner films, positioned between the first outer film and the second outer film, a heat resistant material being spread between the two inner films;
a hot sealing side, positioned on a folded side of the first outer film and the second outer film and formed by adhering the first outer film to the second outer film by means of hot sealing;
at least one first air chamber, positioned between the first side and the hot sealing side and being an air storable space formed by adhering the first outer film to the second outer film by means of hot sealing;
at least one second air chamber, positioned between the second side and the hot sealing side and being an air storable space formed by adhering the first outer film to the second outer film by means of hot sealing;
at least one air inlet, positioned on the first outer film and used for communicating the first air chamber with the second air chamber; and
at least one air entrance, formed by adhering the two inner films by means of hot sealing to allow air to enter the first air chamber and the second air chamber to allow the first air chamber and the second air chamber to be filled with air and expanded via the air entrance.

2. The air packing bag for tightly holding an article according to claim 1, wherein the two inner films are respectively adhered and attached onto the first outer film and the second outer film by means of hot sealing.

3. The air packing bag for tightly holding an article according to claim 1, further comprising an air filling passageway positioned at one side of the first air chamber and being an air passable space formed by adhering the first outer film to the second outer film by means of hot sealing, air in the air filling passageway being filled in the first air chamber via the air entrance.

4. The air packing bag for tightly holding an article according to claim 1, further comprising at least one hot pressing node formed by adhering the first outer film to the second outer film by means of hot sealing, the article being allowed to let in the hot pressing node when the first air chamber and the second air chamber are filled with air and expanded.

5. The air packing bag for tightly holding an article according to claim 4, further comprising at least one circular loop potion surrounding the hot pressing node, the article being wrapped by the circular loop portion when the article is let in the hot pressing node.

6. The air packing bag for tightly holding an article according to claim 1, further comprising a suspension hole positioned on the hot sealing side and used for allowing a hook to pass through to provide a suspension use.

7. The air packing bag for tightly holding an article according to claim 1, wherein upper and lower parts of the folded first outer film is adhered to each other by means of hot sealing to shield the accepting space.

8. The air packing bag for tightly holding an article according to claim 1, wherein air in the accepting space is evacuated to allow the first air chamber and the second air chamber to tightly hold the article.

9. The air packing bag for tightly holding an article according to claim 1, wherein the air inlet if formed by piercing the first outer film through after the first outer film is folded up, and a periphery of the air inlet is hot-sealed to allow the accepting space not to communicate with the first air chamber and the second air chamber.

10. The air packing bag for tightly holding an article according to claim 1, further comprising at least one cutting line positioned between each two adjacent first air chambers and between each two adjacent second air chambers.

11. A method for manufacturing an air packing bag for tightly holding an article, comprising the following steps:
providing a first outer film and a second outer film, the first outer film comprising a first side, a second side and a foldable side, the foldable side being disposed between the first side and the second side;
providing two inner films, disposed between the first outer film and the second outer film, spreading a heat resistant material between the two inner films;
folding up the first outer film along the foldable side, forming an accepting space used for depositing an article between upper and lower parts of the folded first outer film;
forming at least one air inlet by piercing the first outer film through;
hot-sealing a periphery of the air inlet;
folding up the second outer film and stacking on an outer side of the first outer film;
adhering the first outer film to the second outer film by means of hot sealing, forming a hot sealing side on a folded side of the first outer film and the second outer film; and
adhering the first outer film to the second outer film by means of hot sealing, forming at least one first air chamber between the first side and the hot sealing side and forming at least one second air chamber between the second side and the hot sealing side.

12. The method for manufacturing an air packing bag for tightly holding an article according to claim 11, further comprising generating hot sealing point points by means of hot sealing thereby respectively adhering and attaching the two inner films onto the first outer film and the second outer film after the step of providing two inner films, disposed between the first outer film and the second outer film, spreading a heat resistant material between the two inner films.

13. The method for manufacturing an air packing bag for tightly holding an article according to claim 11, further comprising adhering the two inner films by means of hot sealing to form at least one air entrance to allow air to enter the first air chamber and the second air chamber to allow the first air chamber and the second air chamber to be filled with air and expanded via the air entrance after the step of providing two inner films, disposed between the first outer film and the second outer film, spreading a heat resistant material between the two inner films.

14. The method for manufacturing an air packing bag for tightly holding an article according to claim 11, further comprising adhering the first outer film to the second outer film by means of hot sealing to form an air filling passageway, air in the air filling passageway being filled in the first air chamber via the air entrance after the step of adhering the first outer film to the second outer film by means of hot sealing, forming at least one first air chamber between the first side and the hot sealing side and forming at least one second air chamber between the second side and the hot sealing side.

15. The method for manufacturing an air packing bag for tightly holding an article according to claim 11, further comprising piercing a suspension hole on the hot sealing side after the step of adhering the first outer film to the second outer film by means of hot sealing, forming a hot sealing side on a folded side of the first outer film and the second outer film.

16. The method for manufacturing an air packing bag for tightly holding an article according to claim 11, further comprising adhering the first outer film to the second outer film by means of hot sealing to form at least one hot pressing node, the article being allowed to let in the hot pressing node when the first air chamber and the second air chamber are filled with air and expanded After the step of adhering the first outer film to the second outer film by means of hot sealing, forming at least one first air chamber between the first side and the hot sealing side and forming at least one second air chamber between the second side and the hot sealing side.

17. The method for manufacturing an air packing bag for tightly holding an article according to claim 16, further comprising adhering the first outer film to the second outer film by means of hot sealing to form at least one circular loop portion, the article being wrapped by the circular loop portions when the article is let in the hot pressing nodes after the step of adhering the first outer film to the second outer film by means of hot sealing to form at least one hot pressing node.

18. The method for manufacturing an air packing bag for tightly holding an article according to claim 11, further comprising placing an article into the accepting space after the step of adhering the first outer film to the second outer film by means of hot sealing, forming at least one first air chamber between the first side and the hot sealing side and forming at least one second air chamber between the second side and the hot sealing side.

19. The method for manufacturing an air packing bag for tightly holding an article according to claim 18, further comprising providing at least one cutting line positioned between each two adjacent first air chambers and each two adjacent second air chambers after the step of adhering the first outer film to the second outer film by means of hot sealing, forming at least one first air chamber between the first side and the hot sealing side and forming at least one second air chamber between the second side and the hot sealing side.

20. The method for manufacturing an air packing bag for tightly holding an article according to claim 11, further comprising evacuating air in the accepting space to enable the first air chamber and the second air chamber to tightly hole the article after the step of placing an article into the accepting space.

21. The method for manufacturing an air packing bag for tightly holding an article according to claim 18, further comprising adhering the first outer film to the second air chamber by hot sealing to shield the accepting space after the step of placing an article into the accepting space.
